(19) United States
(12) Patent Application Publication
(10) Pub. No.: US 2025/0244979 A1
(43) Pub. Date: Jul. 31, 2025

(54) MACHINE LEARNING BASED STATIC PROFILING

(71) Applicant: Oracle International Corporation, Redwood Shores, CA (US)

(72) Inventors: Milena JANICIC, Zurich (CH); Milan Vujosvic CUGUROVIC, Zurich (CH); Vojin JOVANOVIC, Zurich (CH); Thomas WUERTHINGER, Zurich (CH)

(73) Assignee: Oracle International Corporation, Redwood Shores, CA (US)

(21) Appl. No.: 18/426,290

(22) Filed: Jan. 29, 2024

(51) Int. Cl. G06F 8/41; G06N 20/00

(52) U.S. Cl. CPC G06F 8/443; G06N 20/00

(57) ABSTRACT

Machine learning based static profiling includes obtaining an intermediate representation (IR) graph of source code of a program, extracting multiple control flow split node features of a control flow split node in the IR graph, and processing, by a regression machine learning model, the control flow split node features to generate a branch frequency value of a branch from the control flow split node. The machine learning based static profiling further includes adding the branch frequency value to a profile for the program and executing an optimizer on the program according to the profile to generate optimized code.

### BACKGROUND

Computer programs are often written in a high level programming language. An optimizer of a computer program may modify the program to improve execution of the program on computing systems. For example, optimizations may be performed to reduce execution time and the amount of memory used when the program is executed. Optimizing the program may be performed as part of compiling a program.

Profile-guided optimization (PGO) is a widely used compiler technique that leverages profiles of programs to improve the performance of the compiled programs. Profiles refer to data that characterize a program's execution, such as the number of times each branch was executed, the number of function calls, and the caller-callee relationship between functions. PGO uses profiles to make informed decisions during the compilation process. For example, optimizations may be more aggressively performed in frequently called functions, resulting in more efficient programs. PGO improves various programs.

Profiles may be collected dynamically (i.e., dynamic profiling) or predicted statistically (i.e., static profiling). Dynamic profiling collects the information to populate the profiles while the program is executed. Specifically, the program is instrumented to produce data about the execution of the program (e.g., which functions are executed, etc.). When the program is executed, the data is collected, and the profile generated therefrom. Static profiling does not use an execution of a program. Rather, static profiling is based on estimations and heuristics of how the program may execute.

The execution time speedup that PGO achieves can vary and be more than fifty percent. However, the quality of the PGO optimized programs is dependent on the quality of the profiles. Dynamic profiling provides profiles of the high quality but at a high cost, while static profiling may be less accurate but provide profiles at the lower cost.

### SUMMARY

In general, in one aspect, one or more embodiments relate to a method. The method includes obtaining an intermediate representation (IR) graph of source code of a program, extracting multiple control flow split node features of a control flow split node in the IR graph, and processing, by a regression machine learning model, the control flow split node features to generate a branch frequency value of a branch from the control flow split node. The method further includes adding the branch frequency value to a profile for the program and executing an optimizer on the program according to the profile to generate optimized code.

In general, in one aspect, one or more embodiments relate to a system that includes memory and at least one computer processor for executing computer readable program code to perform operations. The operations include obtaining a IR graph of source code of a program, extracting multiple control flow split node features of a control flow split node in the IR graph, and processing, by a regression machine learning model, the control flow split node features to generate a branch frequency value of a branch from the control flow split node. The operations further include adding the branch frequency value to a profile for the program and executing an optimizer on the program according to the profile to generate optimized code.

In general, in one aspect, one or more embodiments relate to a non-transitory computer readable medium including computer readable program code for causing a computer system to perform operations. The operations include obtaining an IR graph of source code of a program, extracting multiple control flow split node features of a control flow split node in the IR graph, and processing, by a regression machine learning model, the control flow split node features to generate a branch frequency value of a branch from the control flow split node. The operations further include adding the branch frequency value to a profile for the program and executing an optimizer on the program according to the profile to generate optimized code.

Other aspects of one or more embodiments will be apparent from the following description and the appended claims.

### BRIEF DESCRIPTION OF DRAWINGS

FIG. 1 shows a computing system that performs machine learning based static profiling in accordance with one or more embodiments.

FIG. 2 shows a first example of a regression machine learning model in accordance with one or more embodiments.

FIG. 3 shows a second example of a regression machine learning model in accordance with one or more embodiments.

FIG. 4 shows a third example of a regression machine learning model in accordance with one or more embodiments.

FIG. 5 shows a flow diagram of performing profile guided optimization with static profiling in accordance with one or more embodiments.

FIG. 6 shows a flow diagram to train the regression machine learning model to perform static profiling in accordance with one or more embodiments.

FIG. 7 shows a flowchart to perform profile guided optimization with static profiling in accordance with one or more embodiments.

FIG. 8 shows a flowchart for extracting features in accordance with one or

more embodiments.

FIG. 9 shows a table of example features in accordance with one or more embodiments.

FIG. 10 shows an example of a heap sort program.

FIG. 11 shows an example of an intermediate representation (IR) graph and control flow graph generated from the heap sort program of FIG. 10 in accordance with one or more embodiments.

FIG. 12 shows an example of feature extraction using the graphs of FIG. 11 in accordance with one or more embodiments.

FIG. 13A and FIG. 13B show diagrams of a computing system implementing FIG. 1 in accordance with one or more embodiments.

Like elements in the various figures are denoted by like reference numerals for consistency.

### DETAILED DESCRIPTION

One or more embodiments are directed to optimizing using machine learning based static profiling. Static profiling involves estimating which instructions are executed and the frequency of executing each instruction. The instructions that are executed and the frequency of execution of the instructions are dependent on the control flow, such as evaluation of conditional expressions, which is determined when a program is executed.

To perform static profiling, an intermediate representation (IR) graph is generated for a program. The IR graph includes control flow split nodes. A control flow split node is a node representing where the control flow split of the program may deviate along different paths, such as based on a conditional expression. The control flow split node has multiple branches leading from the control flow split node, each branch for a different path. One or more embodiments extract control flow split node features for the control flow split node from the IR graph. A regression machine learning model processes the extracted control flow split node features and predicts the relative frequency of each branch being executed. The result is saved as part of the static profile. An optimizer then optimizes the program using the static profile to generate an optimized program. Because the static profile is more accurate by way of the regression machine learning model, the optimizations on the program are more precise.

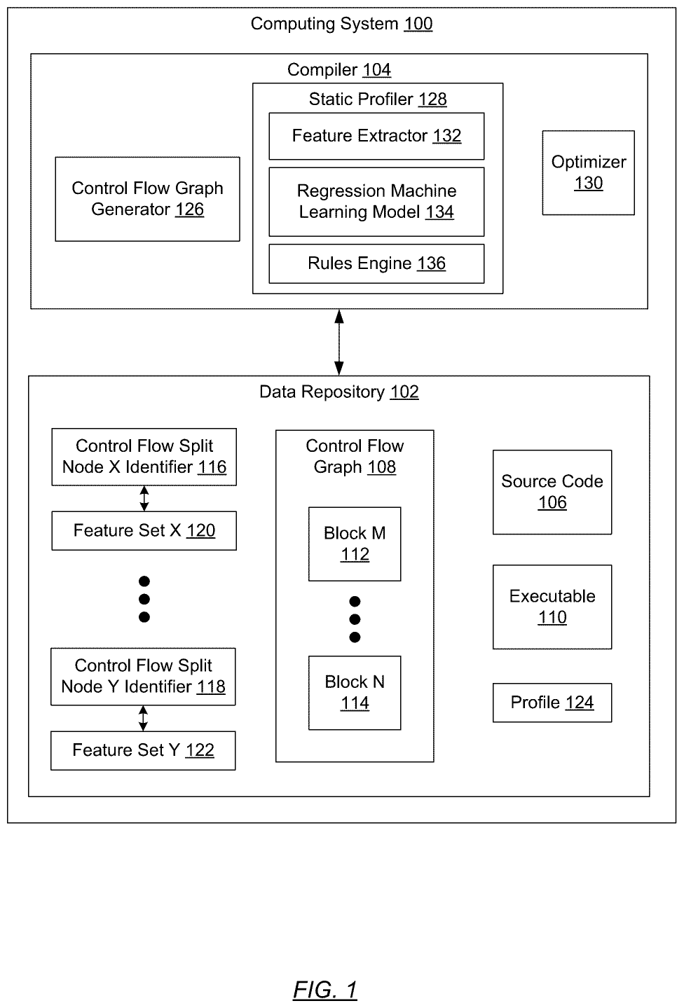

Turning to FIG. 1, FIG. 1 shows a computing system (100) that performs machine learning based static profiling in accordance with one or more embodiments. As shown in FIG. 1, the computing system (100) includes a data repository (102) connected to a compiler (104).

Attention is now turned to the figures. FIG. 1 shows a computing system, in accordance with one or more embodiments. The system shown in FIG. 1 includes a data repository (102). The data repository (102) is a type of storage unit or device (e.g., a file system, database, data structure, or any other storage mechanism) for storing data. The data repository (102) may include multiple different, potentially heterogeneous, storage units and/or devices.

The data repository (102) may include functionality to store a program. A program is any sequence of instructions written in a computer understandable programming language. The program may be in various states. For example, the program may be written in a source code (106). The source code (106) is written in any programming language. The source code (106) may be compiled to generate an executable (110). The executable (110) may be, for example, a binary or object code. An executable is any form of the program that may be executed.

The program may be processed to create a control flow graph (108). The control flow graph (108) is represents the control flow of the instructions in the source code (106). In one or more embodiments, the control flow graph (108) is a directed graph, referred to as a control flow graph (108), that represents the data flow and the control flow of a program. The directed graph may be in static single assignment (SSA) form. The control flow graph (108) includes multiple blocks. The control flow graph (108) may be generated from an IR graph having IR nodes. Each IR node produces at most one value. For example, the IR node may be for an operand or an operator of a statement in the program. To represent data flow, an IR node has input edges pointing to the IR node(s) that produce its operands. To represent control flow, an IR node has successor edges pointing to its successors. Thus, the IR graph is a superposition of two directed graphs: the data-flow graph and the control-flow graph (108).

IR nodes of the IR graph may be floating nodes or fixed nodes. The floating nodes represent the data flow (e.g., addition, subtraction, multiplication, division, bitwise operations, type conversions, and more). The floating nodes represent value propagation between instructions. Floating nodes can take inputs from other floating nodes or constants embedded in the program and produce output values used by subsequent instructions. Fixed nodes represent function calls, memory loads and stores, bytecode exceptions, control flow constructs, etc. Fixed nodes include control flow split nodes and merge nodes along with other nodes.

Control flow split nodes are nodes representing where a single path is split into multiple paths. For example, control flow split nodes may represent a conditional expression, such as a start of a loop, an “if statement” or other statement that may cause nodes to split. The edges leading from the control flow split nodes are branches from the control flow split nodes. Control flow split nodes may have two or more branches leading directly from the control flow split nodes. Namely, the control flow split node may split the incoming path into two or more branches in one or more embodiments.

Merge nodes are fixed nodes that merge control flow paths within the IR graph (108). Merge nodes represent a point in the program where multiple control flow paths converge into a single path. Thus, merge nodes have two or more branches leading to the merge nodes. Phi nodes merge floating nodes and represent a value that can come from multiple possible sources. Pi nodes represent a value that has been narrowed down to a more specific type. Loops in the program are represented by a loop begin node indicating the beginning of the loop and one or more loop exit nodes indicating an exit from a loop.

The control flow graph (108) is a representation, using graph notation, of the paths that might be traversed through a target program during the execution of the target program. The control flow graph (108) includes blocks (e.g., block M (112) block N (114)). A block is a logical structure that includes a set of IR nodes that are connected to each other in the IR graph. Each block is a discrete set of IR nodes that is disjoint from the IR nodes in other blocks. Within a block, a single path exists amongst the IR nodes. Specifically, a block has a single control flow in which if one instruction in the block is executed, then the other instructions in the block are executed. Thus, control flow split nodes are last nodes of a block. Merge nodes may be at the beginning of a block. Other types of IR nodes may cause the start or end of a block.

Continuing with FIG. 1, the data repository (102) may also store relationships between control flow split node identifiers (e.g., control flow split node X identifier (116), control flow split node Y identifier (118)) and corresponding feature sets (e.g., features set x (120), feature set y (122)). The control flow split node identifiers are unique identifiers of control flow split nodes in the IR graph (108). The feature set is the set of features extracted for the corresponding control flow split node (i.e., the control flow split node connected to the feature set). The feature set may include one or more of: one or more features of extracted from the control flow split node, one or more features extracted from the hosting block that hosts the control flow split node, one or more features extracted from at least one predecessor block that is a predecessor of the control flow split node, and one or more features that are extracted from a dominated blocks that is dominated by the control flow split node. The hosting block is the block in the control flow graph that includes the control flow split node. The predecessor block is a block in the control flow graph that contains the predecessor of the IR node of the hosting block. Specifically, instructions represented by IR nodes in the predecessor blocks are executed prior to instructions represented by the IR nodes in the hosting block.

Dominated blocks have successor blocks of the hosting block that are dominated by the control flow split node. Dominated blocks are blocks having IR nodes that represent instructions whose execution is dependent on the evaluation of the control flow split node. Namely, whether the instructions represented in the dominated blocks are executed depends on the control flow split node.

In one or more embodiments, multiple sets of dominated blocks may exist, whereby each set is for a different branch split from the control flow split node. Each set of dominated blocks are blocks that are linked to each other (e.g., are connected). A set of dominated blocks stop where the different branches that split from the control flow split node merge.

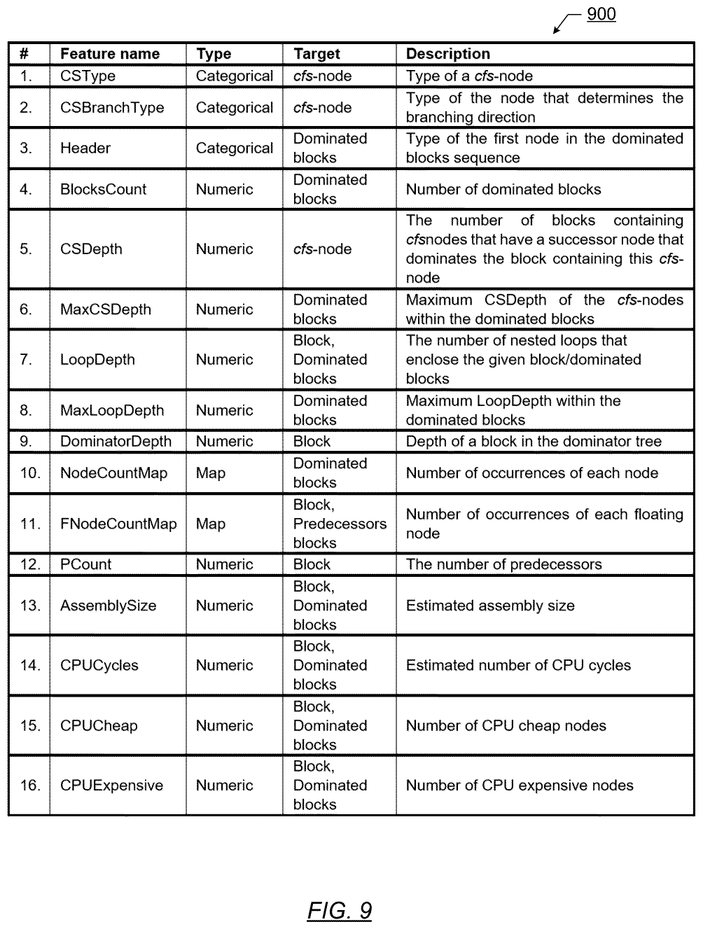

The feature set includes categorical and numerical features in accordance with one or more embodiments. Categorical features are features that are defined by category value. Numerical features have a numerical value. Some of the features may be predicted features. A predicted feature is a feature that is predicted based on attributes of the corresponding block or node. For example, processing cycles may be a predicted feature that is predicted based on type of IR node. Example features are described in FIG. 9.

Continuing with FIG. 1, the data repository (102) further includes functionality to store a profile (124) for the program. The profile is a static profile that estimates how the program executes. For example, for each block or intermediate execution node, the profile (124) may include an estimated execution frequency of the instructions in the block or control flow node. The profile (124) may also include data type information, determined variable values, and other information.

The data repository (102) is connected to the compiler (104). The compiler (104) is software that converts instructions into a machine-code or lower-level form so that the program can be read and executed by a computing system. The compiler (104) is configured to perform static analysis of the program and perform optimizations as described herein.

The compiler (104) includes a control flow graph generator (126), a static profiler (128), and an optimizer (130). The control flow graph generator (126) is configured to generate the control flow graph (108) for a program.

The static profiler (128) is configured to generate a static profile (i.e., profile (124)) of the program using the IR graph and the control flow graph (108). The static profiler (128) includes a feature extractor (132), a regression machine learning model (134), and a rules engine (136). The feature extractor (132) is configured to extract features for the feature set from the IR graph.

The regression machine learning model (134) is a machine learning model that includes functionality to receive a feature set and output an estimation of the execution frequency. In one or more embodiments, the regression machine learning model (134) is configured to output the execution frequency of at least one branch from the control flow split node. In one or more embodiments, control flow split nodes have two or more branches, each branch with a corresponding predicted execution frequency. The predicted execution frequency may be a relative frequency that is relative to the predicted execution frequency of the other branches. In one or more embodiments, the predicted execution frequency is a rational number between zero and one. Further, the predicted execution frequency summed across all branches may total to one.

In some embodiments, the static profiler (128) processes control flow split nodes that split into two branches differently than control flow split nodes that split into more than two branches. For example, control flow split nodes that split into two branches may be processed using the regression machine learning model, while control flow split nodes that split into more than two branches have each branch treated as having equal predicted execution frequency. Namely, control flow split nodes that split into more than two branches may be predicted as having equal execution frequency.

In some embodiments, the regression machine learning model (134) may process control flow split nodes that split into more than two branches the same as control flow nodes that split into two branches.

The regression machine learning model (134) is trained to learn the relationship between features in the feature set and the execution frequency. In one or more embodiments, the regression machine learning model is trained using supervised learning. Supervised learning uses a labeled dataset to train the machine learning model to learn a mapping between features and corresponding labels (i.e., the predicted execution frequency) for instances in the training dataset. The machine learning model contains parameters, and the learning includes tuning the model parameters to minimize the prediction error. In the regression machine learning model, the model prediction error may be measured using the Mean Squared Error (MSE) and Root Mean Square Error (RMSE). MSE computes average squared differences between predicted and actual values. RMSE computes the square root of the MSE. The training of the regression machine learning model aims to generalize the learned mapping to predict new, unseen data accurately.

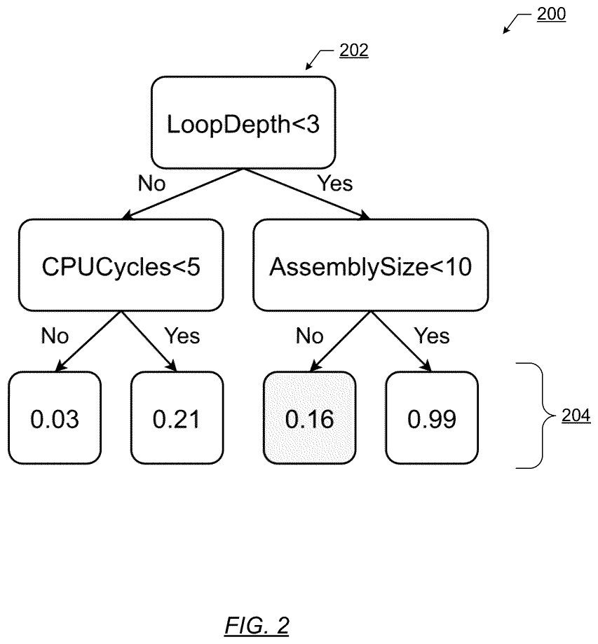

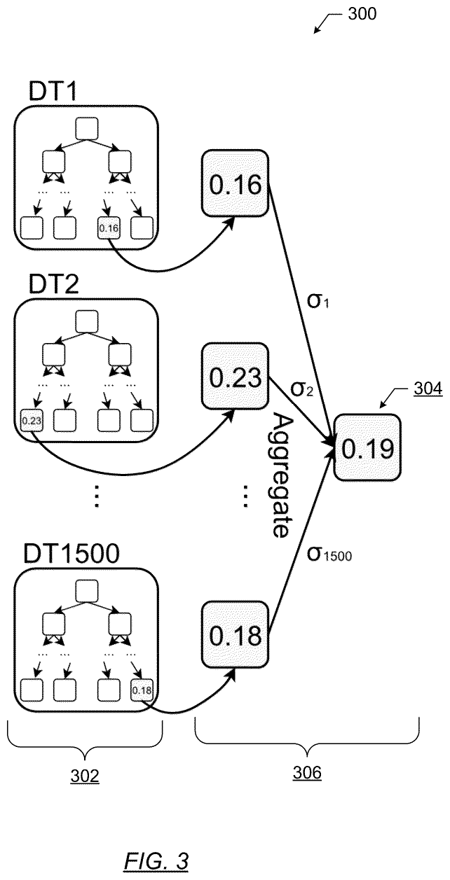

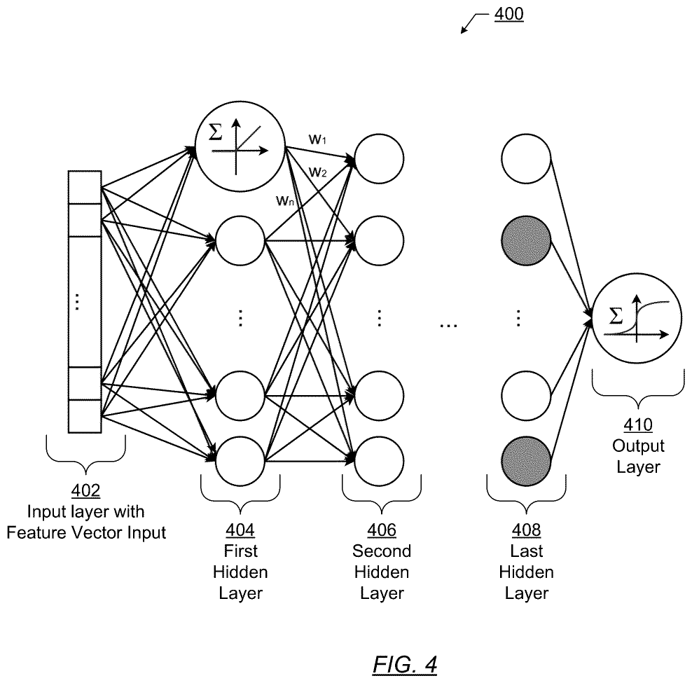

In the training process, instance weights can prioritize the individual instances, focusing the regression machine learning model to more accurately predict instances with higher weights. Using instance weights, the machine learning model can prioritize certain samples and improve performance in particular areas of interest. Using instance weights alters the interpretation of MSE and RMSE. The MSE and RMSE no longer uniformly measure the average deviation of predictions from actual values across all instances. Instead, the MSE and RMSE assign greater significance to instances with larger weights. The weighted MSE and RMSE provide a more comprehensive evaluation of model quality, considering the varying importance of different instances based on their respective weights. FIG. 2, FIG. 3, and FIG. 4 show examples of regression machine learning models that may be used.

Continuing with the static profiler (128), a rules engine (136) is configured to apply a set of heuristic rules to the predicted execution frequency. A heuristic rule is a rule that defines a modification of the predicted execution frequency based on a property of the corresponding branch. For example, a heuristic rule may be that a branch leading to a loop body has a predicted execution frequency that is greater than or equal to a minimum threshold. As another example, a heuristic rule may be that a branch leading to an end of a program has a predicted execution frequency that is less than or equal to a maximum threshold. The rules engine (136) may be configured to apply other heuristic rules may be used without departing from the scope of the invention.

The optimizer (130) includes functionality to optimize the program based on the profile (124). For example, the optimizer (130) may remove unreachable code, perform loop unrolling, and perform other optimizations.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a first example of a regression machine learning model (200) in accordance with one or more embodiments. Specifically, FIG. 2 shows an example of a regression decision tree model (200). The regression decision tree model (200) uses a tree structure to model the data. The tree structure includes decision tree (DT) nodes and edges connecting the nodes. The root node is the topmost node of the regression decision tree model that has no parent node. The bottom most node of the decision tree structure is a leaf node (204). Each intermediate DT node examines one of the features in the feature set to obtain a result. Based on the result, the regression decision tree model (200) descends to the child DT node in the decision tree along a particular edge from the examined intermediate DT node. Leaf DT nodes (204) include the predicted execution frequency. Leaf nodes are used for prediction of the outcome values.

Training the regression decision tree model involves selecting features whose values will be examined in the internal nodes and values that the decision tree leaves predict.

In the example of FIG. 2, a shallow regression decision tree model (200) is shown. The shallow regression decision tree model (200) examines only three features that characterize a particular control flow split node: loop depth, assembly size, and the number of central processing unit (CPU) cycles. By way of a specific example, consider the scenario in which a control flow split node at the top of the function (i.e., at the loop depth of 0) has an assembly size of 5 bytes. In the specific example, the regression decision tree model in FIG. 2 predicts the control flow split node execution probability to be 0.16.

Training the regression decision tree starts with the root node containing all the training set's data. Training chooses the best feature to split the data and minimize entropy or impurity in the child nodes. Entropy is a measure of disorder or uncertainty in the data, and the DT training algorithm aims to split the data in a way that reduces the entropy as much as possible. Data impurity is measured using the MSE, i.e., average squared distances between original and predicted values.

Overfitting may occur if the tree is too complex and fits the training data too closely, leading to poor performance on new, unseen data. Pruning may be performed to simplify the regression decision tree model and involves removing decision tree branches after the decision tree has been built. Post-pruning iteratively removes the subtrees with the most negligible impact on the regression decision tree model performance.

FIG. 3 shows a second example of a regression machine learning model (300) in accordance with one or more embodiments. Specifically, FIG. 3 shows an example of a forest ensemble model (300). Regression ensemble models are collections of multiple regression machine learning models (302) that collectively make decisions. The regression ensemble model uses model aggregation (306) to reduce variance and may result in a more stable and reliable predictions. Gradient boosting training iteratively adds new machine learning models to the ensemble, each successive machine learning model (302) trying to correct the errors of the previous machine learning model. Training using the gradient boosting algorithm fits each new machine learning model (302) to the residuals (i.e., the errors) of the previous models so that the new machine learning model can capture the patterns that the previous machine learning models missed. One type of regression ensemble machine learning model (300) is an extreme gradient boosting model (XGBoost) as shown in FIG. 3. XGBoost works by iteratively adding regression decision tree models (302) (e.g., as shown in FIG. 2) to the regression machine learning model (300), with each regression decision tree model attempting to correct the errors made by the previous regression decision tree models. The final predicted execution frequency (304) may be aggregate of the predictions of the regression decision trees (302). For example, the aggregation (306) may be a weighted average.

FIG. 4 shows a third example of a regression machine learning model (400) in accordance with one or more embodiments. Specifically, FIG. 4 shows an example of a regression neural network model (400). The regression neural network model (400) includes multiple layers of neurons that transform an input feature vector into an output prediction, whereby the output prediction is the predicted execution frequency of at least one branch. The input layer (402) is the first layer (402) in the network. The input layer (402) has as many neurons as there are features in the feature vector. Intermediate layers in the network are called hidden layers (e.g., first hidden layer (404), second hidden layer (406), last hidden layer (408)).

The neural network with more than one hidden layer is called a deep neural network (DNN). The last layer in the regression neural network (400) is called the output layer (410).

Each layer in the regression neural network (400) includes multiple neurons (also referred to as neural network nodes) connected to the neurons in the previous layer. Each input layer neuron receives and distributes feature value, allowing the network to process and learn from the input feature vector. Each particular neuron from the hidden and output layers computes a weighted sum of the input to the particular neuron. The weighted sum is then passed through an activation function to produce the output of the particular neuron. The activation function is a non-linear function that introduces non-linearity to the regression neural network model, allowing the regression neural network to learn complex patterns and relationships in the features. For example, the activation function may be the Rectified Linear Unit (ReLU) activation function (i.e., relu(x)=max(0, x)). As another example, the activation function may be the sigmoid activation function

$$( i . e . , σ ( x ) = \frac{1}{1 + {e}^{- x}} ) ,$$

which fits the model prediction in the range of zero to one, and the hyperbolic tangent function

$$( i . e . , tanh ( x ) = \frac{{e}^{x} - {e}^{- x}}{{e}^{x} + {e}^{- x}} ) .$$

Weights associated with a neuron determine the strength of the neuron's connections to other neurons. The weights are adjusted during training to minimize the difference between predicted and actual output. The weights may be adjusted during the training of the regression machine learning model. Dropout may be performed as a regularization technique in which randomly selected neurons are temporarily ignored or “dropped out” during the training. Dropout may be performed to prevent overfitting and improve model generalization performance.

The example regression neural network model (400) of FIG. 4 predicts a single real number. The output layer (410) has only one neuron. Neurons from hidden layers use the ReLU activation function in the example, while the neuron from the output layer uses the Sigmoid activation function in the example. Dropped out neurons are shown as the gray-colored filled neurons.

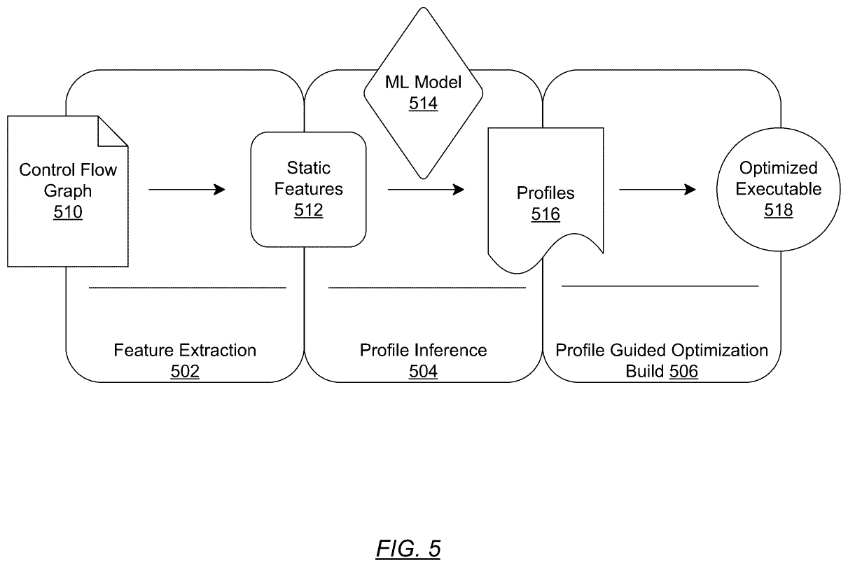

The example regression machine learning models of FIG. 2, FIG. 3, or FIG. 4 may generate predicted execution frequency, which the compiler/optimizer will use to perform profile guided optimization. FIG. 5 shows a flow diagram of performing profile guided optimization with static profiling in accordance with one or more embodiments. As shown in FIG. 5, profile guided optimization includes multiple phases. The phases include feature extraction (502), profile inference (504), and profile guided optimization build (506). Feature extraction (502) is a process that extracts static features (510) (i.e., the feature sets described in reference to FIG. 1) from the IR graph (510) using the control flow graph of the program.

During the profile inference phase (504), the regression machine learning model (514) (discussed above with reference to FIGS. 1-4) determine estimated execution frequencies to populate the profile(s) (516) of the program by analyzing the static features (512). During the profile guided optimization stage (506), the program is optimized, and optionally compiled, to create the optimized executable (518). The optimized executable may then be executed. Because of the static profile being more accurate, the resulting optimized executable has improved optimizations. Thus, the computer on which the program executes may be more responsive as fewer resources are needed to execute the program.

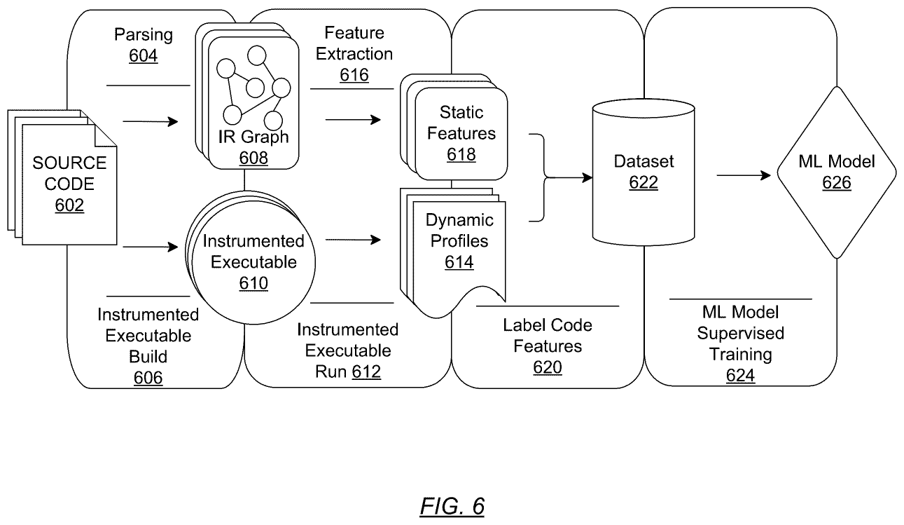

FIG. 6 shows a flow diagram to train the regression machine learning model to perform static profiling in accordance with one or more embodiments. Specifically, FIG. 6 shows an example of dataset creation process that leads to the training the regression machine learning model.

As discussed above, the regression machine learning model is trained by supervised learning. Supervised learning trains the regression machine learning model using a labeled dataset. In a labeled dataset, control flow split nodes are characterized by a set of features and associated with the correct output. The regression machine learning model learns the relationships between the input features and the target values.

As shown in FIG. 6, the dataset creation process starts by selecting a corpus of programs. The selected corpus of programs is training programs or programs used for training, and the source code of the training program is training source code. The source code (602) of each training programs is parsed to generate a corresponding training IR graph (608).

The training source code of the training program is instrumented and built during the instrumented executable build process (606). Instrumenting the training source code may be performed by adding counting nodes to the IR of the training source code. The IR with the counting nodes may be used to generate an executable build, which, when executed, causes the training source code to output information about the execution. For example, the instrumentation may include outputting timestamps and code section identifiers of the code sections or instructions that are being executed. The result of the instrumented executable build process is an instrumented executable (610), which is an instrumented version of the training program that may be executed. The instrumented executable may be referred to as an instrumented program.

The instrumented program is executed in an instrumented executable run (612) to generate a dynamic profile (614) of the instrumented program. Multiple independent executions of the same program may be performed with different input data to the program. Similarly, the instrumentation may be performed on multiple training programs to create a large corpus of training data.

Continuing with FIG. 6, features are extracted (616) from the training IR graph (608) to generate a set of static features (618). The static features include training control flow split node features that are extracted for a training control flow split node (i.e., the control flow split node identified for training). The dynamic profiles (614) are used to determine the execution frequency of each branch of the training control flow split nodes in a label code features process (620). In one or more embodiments, the execution frequency in the dynamic profile is adjusted to be a relative execution frequency that is relative to the branches of the control flow split node. Namely, the relative execution frequency is a percentage of number of times a branch is taken as compared to the total number of times any branch is taken. Thus, a labeled dataset (622) is created whereby training control flow split nodes are related to a feature set of static features (618) and actual execution frequencies determined from the dynamic profiles (614).

The machine learning supervised training process (624) is performed to train the regression machine learning model (626). In general, the regression machine learning model processes the training control flow split node features to generate a predicted branch frequency value of a branch leading from the training control flow split node. The predicted branch frequency value is added to the predicted static profile for the training program. A loss between the dynamic profile and the predicted profile is determined. Determining the loss involves calculating a difference between an execution frequency for the control flow split node obtained from dynamic profile in the dataset (622) and the predicted branch frequency for the control flow split node. The process is repeated for the one or more training programs. The regression machine learning model (626) is updated according to the loss.

During training, various processes may be used to select the static features for extraction. For example, variance-based feature selection or principal component analysis (PCA) may be used. Dimensionality reduction may be used to improve the regression machine learning model performance and reduce overfitting.

Variance-based feature selection involves ranking the input features based on the variance of the features and selecting only the most relevant features. Features with low variance, i.e., those that do not vary much across the dataset, are removed because the low variance features cannot contribute much to the regression machine learning model's predictive power.

Principal component analysis transforms a high-dimensional dataset into a lower-dimensional space by identifying principal components. Principal components are linear combinations of the original features, mutually orthogonal. Principal components capture the directions of maximum variance in the data. Principal component analysis ranks principal components by the degree of variance they explain in the data. The first principal component captures the direction of maximum variance in the dataset. Subsequent components are ordered to explain as much remaining variance as possible and are orthogonal to the previously identified components. To reduce the dimension and explain the maximum variance, the n most important features are selected, where n corresponds to the desired dimension of the space. Unlike feature selection algorithms, the use of the principal component analysis algorithms impairs interpretability. Applying the principal component analysis algorithm results in a new feature set, making the new feature set unfeasible to describe the regression machine learning model's behavior in terms of the initial attributes.

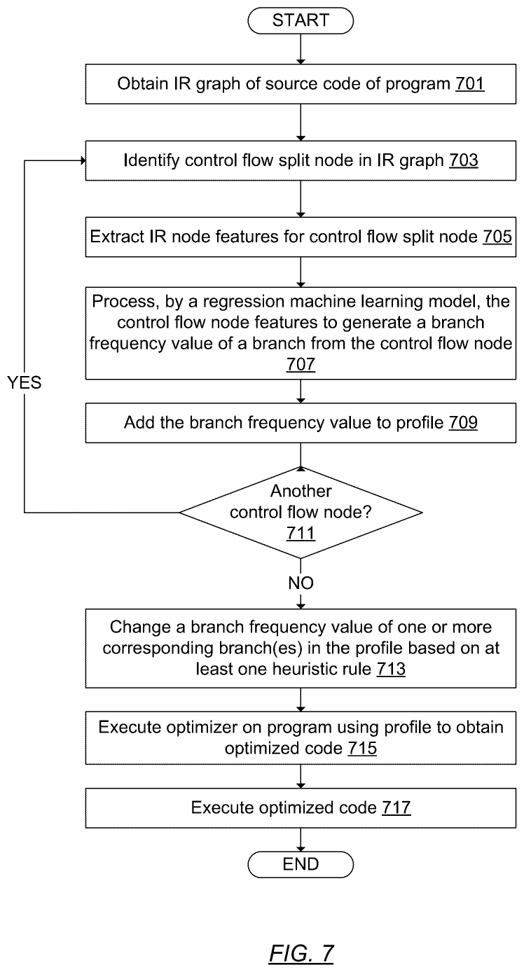

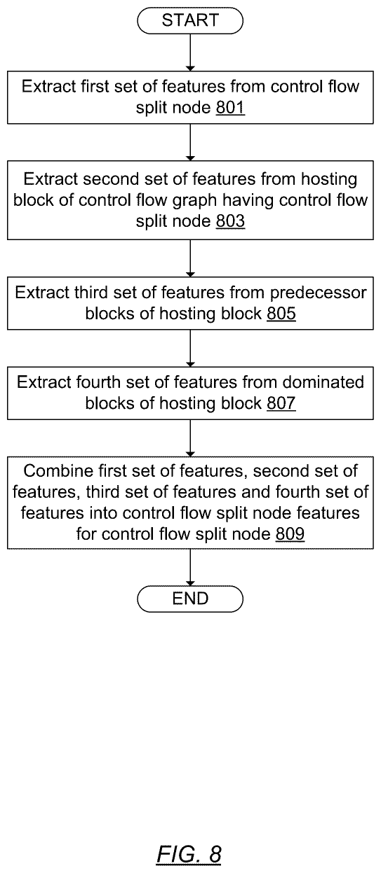

FIGS. 7 and 8 show flowcharts in accordance with one or more embodiments. The processing of FIGS. 7 and 8 may be performed by the various components described in FIGS. 1-6. While the various steps in these flowcharts are presented and described sequentially, at least some of the steps may be executed in different orders, may be combined or omitted, and at least some of the steps may be executed in parallel. Furthermore, the steps may be performed actively or passively.

FIG. 7 shows a flowchart to perform profile guided optimization with static profiling in accordance with one or more embodiments. In Block 701, an IR graph of the source code of the program is obtained. A compiler may parse the source code to generate an abstract syntax tree (AST). From the AST, the compiler may generate the IR graph. The compiler may generate create the control flow graph from the IR graph. Static information specific to the AST node may be precomputed by evaluating the AST nodes. As another example, the compiler generator may obtain the IR graph for the AST node from a repository that stores previously generated IR graphs for AST nodes.

When creating the control flow graph, blocks of the control flow graph are defined. The blocks are identified, based on part on which IR nodes are control flow split nodes and which nodes are merge nodes. Other partitioning of a block into smaller blocks may be performed based on additional rules.

In Block 703, a control flow split node is identified in the IR graph. Identifying the control flow split node may be based on the type of control flow split node in the IR graph.

In Block 705, the IR node features are extracted for the control flow split node. Features may be numerical or categorical. Numerical features represent quantitative data in form of integers or real numbers. Numerical features may be extracted directly from the IR graph or otherwise determined from the IR graph. Categorical features can take a limited number of possible values, which may be represented as text categories. Categorical features are converted into a different format for the regression machine learning model. For example, extracting categorical features may be performed using one-hot encoding. One-hot encoding creates a vector with binary values for each category. Each vector has a length equal to the number of categories and contains zeros in all positions except for the one corresponding to the category that the feature represents, which is set to one. Extracting features in accordance with one or more embodiments may be performed as described below in reference to FIG. 8.

In Block 707, the regression machine learning model processes the control flow node features to generate a branch frequency value of a branch from the control flow node. In one or more embodiments, the regression machine learning model outputs a branch frequency value identifying the predicted branch frequency of at least one branch. If the regression machine learning model operates on binary branches, the outputted branch frequency value may be for the branch that evaluates to true, and the branch frequency value of the other branch may be calculated as one minus the outputted branch frequency value. In other embodiments, the regression machine learning model may be configured to output a branch frequency value for each branch.

In Block 709, the branch frequency value is added to the profile. Identifiers of branches leading from the control flow split node in the profile are updated with the branch frequency values. As another example, the IR graph may be augmented to add an attribute of each branch edge of the branch frequency value.

In Block 711, a determination is made whether another control flow node exists. For example, the static profile may iterate to the next control flow node. If another unprocessed control flow node exists, the process continues with Block 703.

Continuing with FIG. 7, in Block 713, the branch frequency value of one or more corresponding branches in the profile may be changed based on at least one heuristic rule. For example, one such rule is a loop body rule. A control flow split node marked loop begin may be used to detect that the succeeding set of control flow split nodes are a loop body. For each control flow split node that having a branch leading to a loop body, the control flow split node is analyzed in relation to the loop branch rule. The analysis is performed as follows.

Based on the corresponding branch being to a loop body, the branch frequency value is compared to a minimum threshold. If the branch frequency value is less than the minimum threshold (e.g., 0.2), then the branch frequency value is changed to a revised value responsive to the branch frequency value being less than the minimum threshold. For example, the revised value may be the minimum threshold. As another example, the revised value may be a predefined value that is greater than the minimum threshold.

As another example, another heuristic rule may be a program end rule. A control flow split node leading to program end node may be identified. For each control flow split node having a branch leading to a program end, the control flow split node is analyzed in relation to the program end rule. The analysis is performed as follows.

Based on the corresponding branch being to a program end, the branch frequency value is compared to a maximum threshold (e.g., 0.8). If the branch frequency value is greater than the maximum threshold, then the branch frequency value is changed to a revised value responsive to the branch frequency value being greater than the maximum threshold. For example, the revised value may be the maximum threshold. As another example, the revised value may be a predefined value that is less than the maximum threshold. In some embodiments, additional criteria may be applied to determine whether to change the branch frequency value. For example, the determination may be both whether the branch frequency value is greater than the maximum threshold, and whether the other branch has at least a minimum predefined assembly size.

In Block 715, the optimizer is executed on the program using the profile to obtain optimized code. Based on the execution frequency, inlining of code sections and loop unrolling may be performed. The inlining may reveal further optimizations that may be performed. For example, based on the inlining, further datatype information may be performed and delayed allocation of memory may be enabled. Further, statements that are associated with an empty parameter state are removed from the code. Other optimizations may be performed to generate optimized code. The optimizations may be performed while compiling the program to generate an optimized executable.

In Block 717, the optimized code is executed. Because the more optimized program is created, when the computing system executes the program, the computing system is faster and may use less memory resources.

FIG. 8 shows a flowchart for extracting features in accordance with one or more embodiments. Specifically, FIG. 8 shows extracting features from different portions of the IR graph. Some of the blocks of FIG. 8 may be omitted or modified without departing of the scope of the invention. In Block 801, a first set of features are extracted from the control flow split node. The control flow split node features are determined directly from the properties of the control flow split node, including the control flow split node type, the size, and other properties. Specific features and corresponding extraction of the features is presented in FIG. 9.

In Block 803, a second set of features are extracted from a hosting block of the control flow graph having the control flow split node. The second set of features are determined for each block. The second set of features may be based on the IR node types of nodes in the hosting block. Further, other properties may be used to determine the second set of features. The manner in which the features are extracted is dependent on the type of feature, such as discussed below and in reference to FIG. 9.

In Block 805, a third set of features are extracted from a predecessor block of the hosting block. The predecessor block is the block prior to the hosting block. In some embodiments, the predecessor block is only the immediate prior block. In other embodiments, the predecessor block is the set of preceding blocks up to a previous control flow split node or merge node. The manner in which the features are extracted is dependent on the type of feature, such as discussed below and in reference to FIG. 9.

In Block 807, a fourth set of features are extracted from the dominated blocks of the hosting block. For the fourth set of features, the different branches are treated separately. For example, the fourth set of features may have a first portion that corresponds to one branch of the control flow split node and a second separate portion corresponding to a second branch of the control flow split node. The second portion of the features may be separate from the first portion of features. The manner in which the features are extracted is dependent on the type of feature, such as discussed below and in reference to FIG. 9.

In Block 809, the first set of features, the second set of features, the third set of features, and the fourth set of features are combined into control flow split node features for the control flow split nodes. In one or more embodiments, the first set of features, the second set of features, third set of features, and fourth set of features are concatenated into a feature vector.

FIG. 9 shows a table (900) of example features in accordance with one or more embodiments. The columns of the table identify the property of the feature, such as the feature name, the type of feature, the target from which the feature is extracted, and a description of the feature. The type of feature may be categorical, numerical, or map features. The target of the feature may be a control flow split node (denoted as CFS node in the table), dominated blocks, and hosting block (denoted as block in the table). The rows of the table, with the exception of the header row, are individual features. The description describes the feature. The first column is a row number that is used below for some of the features.

Some of the features may be determined based on projected properties of the instructions corresponding to an IR node when the instructions are executed. For example, each IR node may have an attribute of a node type. Based on information extracted about the execution of instructions corresponding to the node type, properties for the node type are determined. The properties may include assembly size and number of processing cycles of a processor executing the instructions. The assembly size may be the number of bytes of the instructions in assembly language.

Thus, extracting the features may include, identifying for each IR node, the IR node type. Based on the node type, the properties of the node type are obtained from storage and related to the IR node. The properties may be aggregated across the nodes in one or more blocks. For some features, the aggregation is a summation of a particular property across the nodes. For other features, the aggregation may be comparing the particular property to one or more thresholds and determining the number of nodes in the block(s) that satisfy the threshold(s). The following are examples for extracting features.

To determine assembly size (i.e., row 13 of table (900)), the following operations may be performed. Based on a set of nodes in a block of the control flow graph, an assembly size of the block is estimated. Specifically, the assembly size property of each node type of each node in the block is determined. The assembly size property is summed across the blocks. The assembly size is added to the feature set.

The processing cycles feature (i.e., row 14 of table (900)) may be determined as follows. Across a set of nodes in a block of the control flow graph, an estimated number of processing cycles of each node in the set of nodes is summed based on a node type of the node to generate an estimated number of processing cycles of the block. The estimated number of processing cycles of the block are added to the feature set.

The estimated processing cycles of nodes may also be used to determine cheap nodes versus expensive nodes and aggregate statistics about the nodes. The processing cheap nodes have an estimated number of processing cycles, as determined by corresponding node type, to use less than a first threshold number of processing cycles. The number of processing cheap nodes may be totaled across a block. The number of processing cheap nodes may be added to the feature set as CPU cheap feature (i.e., row 15 of table (900)).

The processing expensive nodes have an estimated number of processing cycles, as determined by corresponding node type, to use more than a second threshold number of processing cycles. The number of processing expensive nodes may be totaled across a block. The number of processing expensive nodes may be added to the feature set as CPU expensive feature (i.e., row 16 of table (900)).

Another feature may be based on a number of nodes of each node type in the block. Nodes in blocks may be partitioned into groups of nodes of each node type. The number of nodes in each partition is a feature that may be added to the feature set as the node count map (i.e., row 10 of table (900)).

Another feature may be the number of floating nodes. The number of floating nodes in a block may be counted and added to the feature set as the floating node count (i.e., row 11 of table (900)).

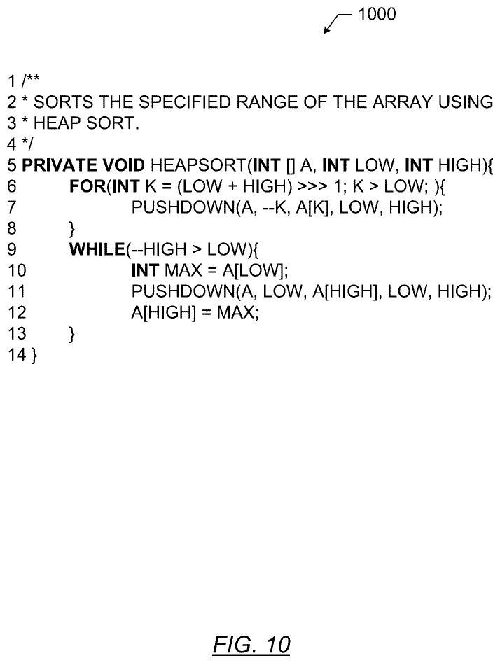

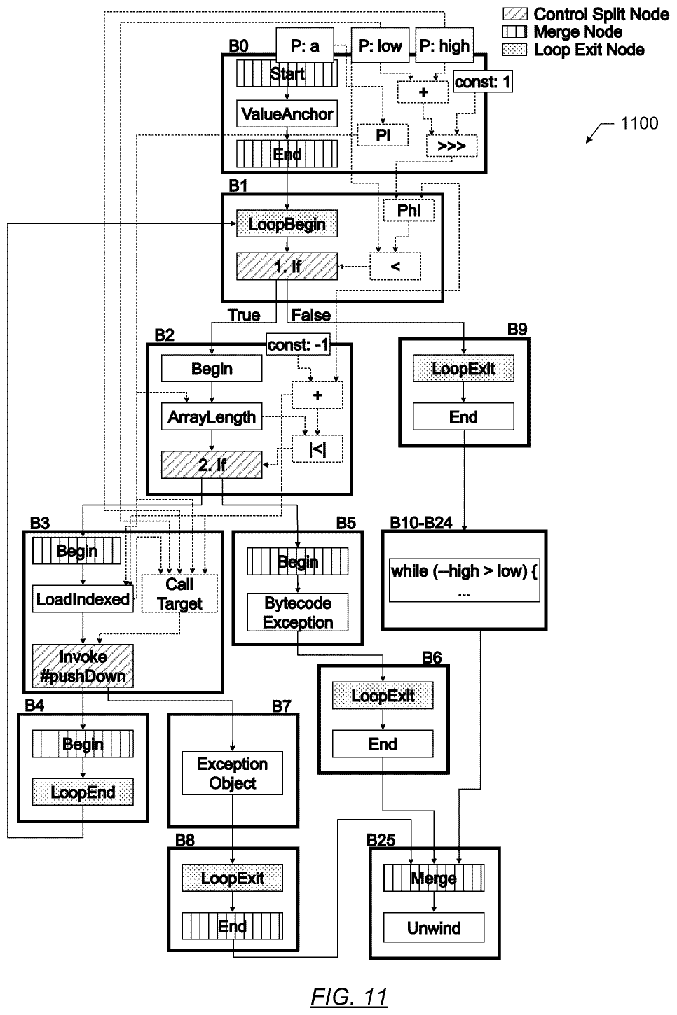

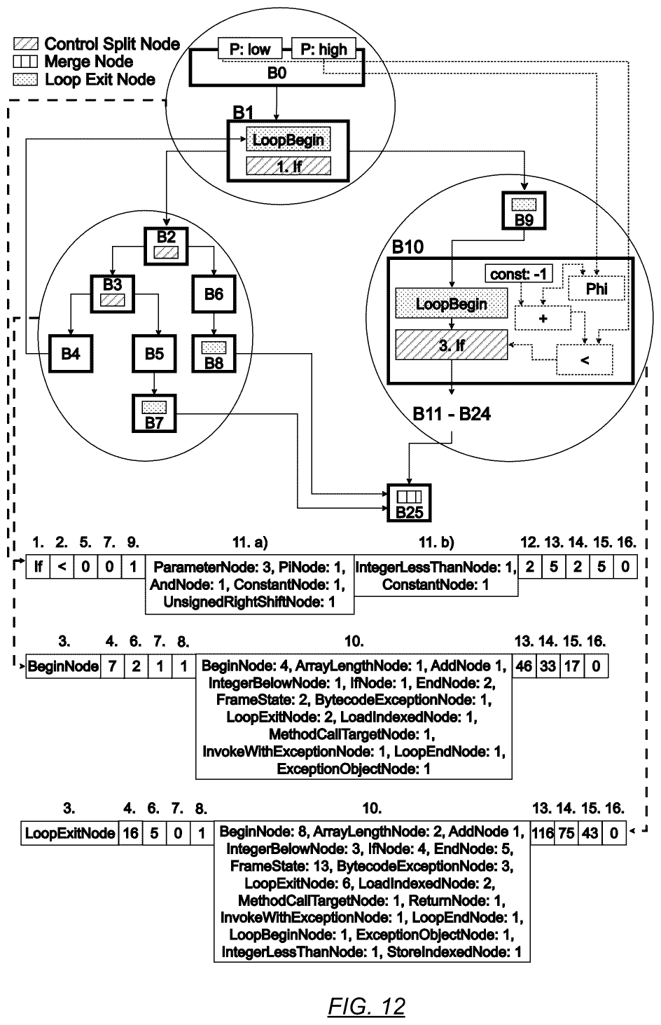

FIG. 10, FIG. 11, and FIG. 12 show an example in accordance with one or more embodiments. In FIG. 11 and FIG. 12, the blocks are identified by B and a number. Blocks with the same identifier are the same. For example, B3 in FIG. 11 is the same block as B3 in FIG. 12. The following example is for explanatory purposes only and not intended to limit the scope of one or more embodiments.

FIG. 10 shows an example of a heap sort program (1000). FIG. 10 shows the Heap Sort algorithm's implementation from the Java Development Kit 17 (JDK17). To sort an array of integers into ascending order, the heapSort function uses the pushDown method that pushes a specified element down the heap.

FIG. 11 shows an example of an IR graph with the control flow graph generated from the heap sort program of FIG. 10 in accordance with one or more embodiments. The IR graph is has the individual IR nodes shown in FIG. 11. The control flow graph has the blocks B0-B25 shown in FIG. 11. The IR graph includes IR graph edges as part of the IR graph. For each binary control flow split node, one or more embodiments characterize the first branch by features that capture the specifics of (i) the control flow split node, (ii) the block B that hosts the control flow split node, (iii) the predecessors' blocks of the block B, (iv) the blocks dominated by the blocks to which control flow graph edges from the block B point. For example, FIG. 11 shows the IR graph and control flow graph that corresponds to the for loop from the program shown in FIG. 10. The control flow split node “1. If” in block B1 has two branches: the first one that points to the Begin node within block B2 and the second one that points to the LoopExit node within block B9. To characterize the first branch of the “1. If” control flow split node, one or more embodiments extract features from (i) the “1. If” control flow split node (ii) the hosting block B1 that hosts the “1. If” control flow split node (iii) the block B0, as a predecessor for the hosting block B1 (iv) the blocks B2-B8 which are dominated by B2 and from blocks B9-B24, which are dominated by block B9. Namely, the execution of blocks B2-B8 is dependent on block B2 while the execution of blocks B9-B24 is dependent on block B9.

The feature set for the example are the sixteen features of the table in FIG. 9. Most of the features have numeric values (11 out of 16 features), three features are categorical, and three features are in the form of vector of integer values. FIG. 12 shows the features extracted for the “1. If” control flow split node. For illustration purposes, extracted features shown in FIG. 11 are numbered using the row numbers of the table shown in FIG. 9.

Most of the features in rows 1-9 of the table (900) of FIG. 9 are numerical. The features in rows 5-9 characterize the control flow of the program. In the example of FIGS. 10-12, as the for loop is on top of the heapSort function, the LoopDepth and CSDepth are 0. Because block B0 dominates hosting block B1, the dominator depth of the block B1 is 1. The maximal nesting level in the blocks dominated by block B2 (dominated blocks that corresponds to the control flow graph edge B1-B2) is 2, as the Invoke node from FIG. 11 has the CSDepth equal to 2. Also, the dominated blocks have a loop depth equal to 1. The dominated blocks that correspond to control flow graph edges B1-B9 are not within the loop and therefore have a loop depth of 0.

Features in rows 1-3 from in table (900) of FIG. 9 are categorical. The CSType feature characterizes the type of the control flow split node and can be IfNode or SwitchNode as those nodes can indicate the branching in the control flow. One or more embodiments use the CSBranchType feature to characterize the logic operation that indicates the branching, for example, comparison of <0, ≤0, etc. For each branch in the control flow, the Header feature characterizes the type of the branch: branch can start with the LoopBegin or Begin node.

The true branch of the “1. If” control flow split node from FIG. 11 corresponds to the control flow graph edge B1-B2. Blocks B2-B8 are dominated by the block B2 and contain a method call (Invoke node), two bytecode exceptions (BytecodeException and ExceptionObject nodes), array element loads (LoadIndexed node), array length checks (ArrayLength node) and two loop exits (LoopExit node). The NodeCountMap feature captures this information, as listed in FIG. 12. Similarly, the FNodeCountMap feature captures the program's data flow information. This map contains only information about floating nodes within the block that host the control flow split node (FIG. 12, feature 11a) and within its predecessors (FIG. 12, feature 11b).

Further, one or more embodiments define an approximation of the CPU cycles and assembly size of the block hosting the control flow split node and the dominated blocks that characterize the CFG edges. Furthermore, one or more embodiments enhanced the feature set by counting the number of nodes that are estimated as CPU cheap (e.g., use 0 or 1 CPU cycles) or CPU expensive (e.g., use more than 64 CPU cycles).

In the example from FIGS. 10-12, the estimated assembly size of the dominated blocks that belong to the loop body is 46 (calculated by summing the estimated assembly sizes of nodes from blocks B2-B8). The estimated assembly size of the dominated blocks that correspond to the loop exit (blocks B9-B24) is 92. For example, block B9 contains two nodes: a LoopExit node estimated at an assembly size of 4 and an EndNode with an estimated assembly size of 0. Blocks dominated by the block B2 have 17 cheap CPU instructions, while those dominated by the block B9 contain 36 such instructions.

Non-numeric features may be encoded. One or more embodiments use one-hot encoding of the categorical features. The Header feature (row 3 of FIG. 9) is a categorical feature. Each branch in the IR can start with a Begin node (e.g., the true branch of the “1. If” control flow split node from FIG. 11) or a LoopExit node (the false branch of the “1. If” control flow split node from FIG. 11). Therefore, this feature can take two categories. The Begin node is encoded as vector <1,0> and the LoopExit node is encoded as <0,1>. The CSBranchType feature (Table 9, feature in row 2) may be a categorical feature that may have one of the 14 values, i.e., one of the 14 floating nodes, which determines the branching direction. For example, “1. If” control flow split node from FIG. 10 executes one of branches depending on comparing the parameter low and the index k. This comparison may be performed with the IntegerLessThanNode (<).

The NodeCountMap and FNodeCountMap features may be encoded as vectors of integers. The length of a vector corresponding to NodeCountMap is 165 (the number of different node types in the IR graph). The length of a vector corresponding to the FNodeCountMap feature is 56 (the number of different floating node types within the IR graph). One or more embodiments preserve node order by sorting the nodes in each vector lexicographically. Accordingly, each node type has a unique position in the encoding vector.

Once the categorical features are one-hot encoded and the maps are transformed into vectors, the features may be concatenated into vectors. Accordingly, a feature vector may be obtained. The feature vector is processed by the regression machine learning model to obtain the estimate relative execution frequency of each branch as described above.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

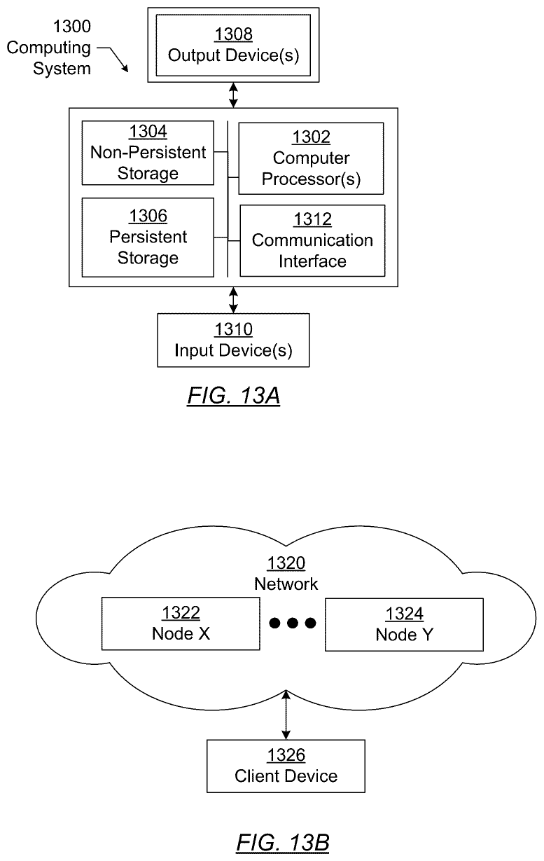

For example, as shown in FIG. 13A, the computing system (1300) may include one or more computer processor(s) (1302), non-persistent storage device(s) (1304), persistent storage device(s) (1306), a communication interface (1312) (e.g., Bluetooth interface, infrared interface, network interface, optical interface, etc.), and numerous other elements and functionalities that implement the features and elements of the disclosure. The computer processor(s) (1302) may be an integrated circuit for processing instructions. The computer processor(s) (1302) may be one or more cores or micro-cores of a processor. The computer processor(s) (1302) includes one or more processors. The computer processor(s) (1302) may include a central processing unit (CPU), a graphics processing unit (GPU), a tensor processing unit (TPU), combinations thereof, etc.

The input device(s) (1310) may include a touchscreen, keyboard, mouse, microphone, touchpad, electronic pen, or any other type of input device. The input device(s) (1310) may receive inputs from a user that are responsive to data and messages presented by the output device(s) (1308). The inputs may include text input, audio input, video input, etc., which may be processed and transmitted by the computing system (1300) in accordance with one or more embodiments. The communication interface (1312) may include an integrated circuit for connecting the computing system (1300) to a network (not shown) (e.g., a local area network (LAN), a wide area network (WAN) such as the Internet, mobile network, or any other type of network) or to another device, such as another computing device, and combinations thereof.

Further, the output device(s) (1308) may include a display device, a printer, external storage, or any other output device. One or more of the output devices may be the same or different from the input device(s) (1310). The input and output device(s) may be locally or remotely connected to the computer processor(s) (1302). Many different types of computing systems exist, and the aforementioned input and output device(s) may take other forms. The output device(s) (1308) may display data and messages that are transmitted and received by the computing system (1300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (1302), is configured to perform one or more embodiments, which may include transmitting, receiving, presenting, and displaying data and messages described in the other figures of the disclosure.

The computing system (1300) in FIG. 13A may be connected to or be a part of a network. For example, as shown in FIG. 13B, the network (1320) may include multiple nodes (e.g., node X (1322), node Y (1324)). Each node may correspond to a computing system, such as the computing system shown in FIG. 13A, or a group of nodes combined may correspond to the computing system shown in FIG. 13A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1300) may be located at a remote location and connected to the other elements over a network.

The nodes (e.g., node X (1322), node Y (1324)) in the network (1320) may be configured to provide services for a client device (1326), including receiving requests and transmitting responses to the client device (1326). For example, the nodes may be part of a cloud computing system. The client device (1326) may be a computing system, such as the computing system shown in FIG. 13A. Further, the client device (1326) may include or perform all or a portion of one or more embodiments.

The computing system of FIG. 13A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining an intermediate representation (IR) graph of source code of a program;
extracting a plurality of control flow split node features of a control flow split node in the IR graph;
processing, by a regression machine learning model, the plurality of control flow split node features to generate a branch frequency value of a branch from the control flow split node;
adding the branch frequency value to a profile for the program; and
executing an optimizer on the program according to the profile to generate optimized code.

2. The method of claim 1, further comprising:
executing the optimized code.

3. The method of claim 1, further comprising:
changing the branch frequency value of a corresponding branch in the profile based on a heuristic rule.

4. The method of claim 3, further comprising:
based on the corresponding branch being to a loop body,
comparing the branch frequency value to a minimum threshold,
wherein changing the branch frequency value is to a revised value responsive to the branch frequency value being less than the minimum threshold.

5. The method of claim 3, further comprising:
based on the corresponding branch being to a program end,
comparing the branch frequency value to a maximum threshold,
wherein changing the branch frequency value is to the maximum threshold responsive to the branch frequency value being greater than the maximum threshold.

6. The method of claim 1, further comprising:
extracting a first set of features from the control flow split node;
extracting a second set of features from a hosting block of a control flow graph, wherein the hosting block comprises the control flow split node, and wherein the control flow graph is generated from the IR graph; and
combining the first set of features and the second set of features into the plurality of control flow split node features.

7. The method of claim 1, further comprising:
extracting a first set of features from the control flow split node;
extracting a second set of features from a hosting block of a control flow graph, wherein the hosting block comprises the control flow split node, and wherein the control flow graph is generated from the IR graph;
extracting a third set of features from at least one predecessor block of the hosting block; and
combining the first set of features, the second set of features, and the third set of features into the plurality of control flow split node features.

8. The method of claim 1, further comprising:
extracting a first set of features from the control flow split node;
extracting a second set of features from a hosting block of a control flow graph, wherein the hosting block comprises the control flow split node, and wherein the control flow graph is generated from the IR graph;
extracting a third set of features from at least one successor block of the hosting block; and
combining the first set of features, the second set of features, and the third set of features into the plurality of control flow split node features.

9. The method of claim 1, further comprising:
extracting a first set of features from the control flow split node;
extracting a second set of features from a hosting block of a control flow graph, wherein the hosting block comprises the control flow split node, and wherein the control flow graph is generated from the IR graph;
extracting a third set of features from at least one predecessor block of the hosting block;
extracting a fourth set of features from at least one successor block of the hosting block; and
combining the first set of features, the second set of features, the third set of features, and the fourth set of features into the plurality of control flow split node features.

10. The method of claim 1,
concatenating the plurality of control flow split node features into a feature vector; and
wherein processing the plurality of control flow split node features comprises processing the feature vector.

11. The method of claim 1, further comprising:
estimating, based on a set of nodes in a block of a control flow graph, an assembly size of the block, wherein the control flow graph is generated from the IR graph; and
adding the assembly size to the plurality of control flow split node features.

12. The method of claim 1, further comprising:
summing, across a set of nodes in a block of a control flow graph, an estimated number of processing cycles of each node in the set of nodes based on a node type of the node to generate an estimated number of processing cycles of the block, wherein the control flow graph is generated from the IR graph; and
adding the estimated number of processing cycles of the block to the plurality of control flow split node features.

13. The method of claim 1, further comprising:
totaling, across a set of nodes in a block of a control flow graph, a number of processing cheap nodes in the set of nodes based on a node type of each node in the set of nodes, wherein the number of processing cheap nodes are estimated to use less than a first threshold number of processing cycles, wherein the control flow graph is generated from the IR graph; and
adding the number of processing cheap nodes of the block to the plurality of control flow split node features.

14. The method of claim 1, further comprising:
totaling, across a set of nodes in a block of a control flow graph, a number of processing expensive nodes in the set of nodes based on a node type of each node in the set of nodes, wherein the number of processing expensive nodes are estimated to use more than a second threshold number of processing cycles, and wherein the control flow graph is generated from the IR graph; and
adding the number of processing expensive nodes of the block to the plurality of control flow split node features.

15. The method of claim 1, further comprising:
partitioning a plurality of nodes in a block of a control flow graph according to a node type of each node in the plurality of nodes to obtain a plurality of partitions, wherein the control flow graph is generated from the IR graph; and
generating a control flow split node feature of the plurality of control flow split node features based on a number of nodes in each partition of the plurality of partitions.

16. The method of claim 1, further comprising:
counting floating nodes in a set of nodes in a block of a control flow graph to obtain a count, wherein the control flow graph is generated from the IR graph; and
adding the count as a control flow split node feature of the plurality of control flow split node features.

17. The method of claim 1, further comprising:
generating a training IR graph of training source code of a training program;
extracting a training plurality of control flow split node features of a training control flow split node in the training IR graph;
processing, by the regression machine learning model, the training plurality of control flow split node features to generate a predicted branch frequency value of a second branch from the training control flow split node;
adding the predicted branch frequency value to a predicted profile for the training program;
instrumenting the training program to obtain an instrumented program;
executing the instrumented program to generate a dynamic profile of the instrumented program;
calculating a loss between the dynamic profile and the predicted profile; and
updating the regression machine learning model according to the loss.

18. The method of claim 17, wherein calculating the loss comprises:
calculating a difference between an execution frequency for the control flow split node obtained from dynamic profile and the predicted branch frequency value for the control flow split node.

19. A system comprising:
memory; and
at least one computer processor for executing computer readable program code to perform operations comprising:
obtaining an intermediate representation (IR) graph of source code of a program;
extracting a plurality of control flow split node features of a control flow split node in the IR graph;
processing, by a regression machine learning model, the plurality of control flow split node features to generate a branch frequency value of a branch from the control flow split node;
adding the branch frequency value to a profile for the program; and
executing an optimizer on the program according to the profile to generate optimized code.

20. A non-transitory computer readable medium comprising computer readable program code for causing a computer system to perform operations comprising:
obtaining an intermediate representation (IR) graph of source code of a program;
extracting a plurality of control flow split node features of a control flow split node in the IR graph;
processing, by a regression machine learning model, the plurality of control flow split node features to generate a branch frequency value of a branch from the control flow split node;
adding the branch frequency value to a profile for the program; and
executing an optimizer on the program according to the profile to generate optimized code.
